(19) United States
(12) Patent Application Publication
(10) Pub. No.: US 2006/0268125 A1
(43) Pub. Date: Nov. 30, 2006

(54) Digital camera system with recyclable memory card

(75) Inventors: Mordechai Teicher, Hod Hasharon (IL); Aran Ziv, Hertzliya (IL); Eyal Bychkov, Hod Hasharon (IL)

Correspondence Address: DR. MARK FRIEDMAN LTD.;C/o Bill Polkinghorn, 9003 Florin Way, Upper Marlboro, MD, 20772, US

(73) Assignee: M-SYSTEMS FLASH DISK PIONEERS, LTD.

(21) Appl. No.: 11/329,073

(22) Filed: Jan. 11, 2006

Related U.S. Application Data
(60) Provisional application No. 60/685,654, filed on May 31, 2005.
(60) Provisional application No. 60/720,057, filed on Sep. 26, 2005.

(51) Int. Cl. H04N 5/76

(52) U.S. Cl. 348/231.99

(57) ABSTRACT

A memory device includes a nonvolatile memory, a medium having instructions for operating the memory device and a processor for executing the instructions. The minimal instructions are instructions for storing, in the nonvolatile memory, original pictures corresponding to source pictures received from a camera, and instructions for producing degraded pictures corresponding to the original pictures. The original pictures are stored either encrypted or clear. The memory device is locked after access of the original pictures by an authorized printer but may be unlocked by the camera from which the original pictures were received. The scope of the invention also includes a corresponding method of digital photography.

This patent application claims the benefit of U.S. Provisional Patent Applications No. 60/685,654, filed May 31, 2005, and No. 60/720,057, filed Sep. 29, 2005.

### FIELD AND BACKGROUND OF THE INVENTION

The present invention relates to digital storage devices, and in particular to such storage devices used for digital photography.

Digital cameras have become commonplace, replacing more and more film cameras in both professional and amateur markets. New possibilities for storing, viewing, processing and printing photographs are now available to anyone having a personal computer and imaging software. However, many users of digital cameras do not use a personal computer, while many users of personal computers prefer the service of a photo shop over printing at home.

Most digital cameras record pictures onto a removable memory card. While conventional photographic film is disposable and can be used only once, memory cards can be reused thousands of times. Many digital camera users have only a single, high-capacity and expensive memory card. Users of such digital cameras use their personal computers to upload the digital pictures from the cards and then burn copies onto CD-ROMs for ordering paper prints at a photo shop. Other users of digital cameras come with their camera or memory card to the photo shop and wait until their photo files are copied to the shop's computer. Many users send their digital pictures to a photo shop through the Internet, and some users approach automated photo printing kiosks for printing. However, the main print ordering method used with photographic films, dropping-off an envelope at a photo shop, is generally unavailable in digital photography because of the cost of the memory cards.

There is thus a need for a system and method that allows users of digital cameras to drop their memory cards at a photo shop without being concerned about the cost of the cards.

### SUMMARY OF THE INVENTION

By “memory card” or “card” is meant a storage device that can be inserted into and removed from a digital camera and that is used to store digital pictures. As understood herein, a “digital camera” (or “camera” for short) can be a dedicated freestanding device or can form part of a larger device such as a video camera with still capability, a cellular telephone or a handheld computer.

By “digital picture” or “picture” is meant an electronic representation of a still picture taken by a digital camera. A “source picture” is a digital picture as taken by the camera's sensor and (optionally) processed by the camera's processor; the source picture represents a high-quality picture, adequate for printing, sent by the camera's processor to a memory card. Source pictures are known in the art either to be in raw format, i.e. as captured by the camera's sensor, or to include in-camera processing for obtaining white balance, sharpening, noise reduction and compression. Some cameras may produce more than one source picture from a single shot, for example both raw and compressed versions, or a sequence of pictures that vary by in-camera processing parameters such as white balance settings. However, thumbnails, if such are produced by the camera's processor for being presented on the camera's own display, are not considered source pictures herein because thumbnails do not represent high quality pictures for printing. An “original picture” is a copy of a source picture stored in a memory card. An original picture can be stored as a “clear original picture” recognizable by standard hosts or as an “encrypted original picture” that can be decrypted only by authorized hosts.

By “host” is meant any electronic device that can be operationally connected to a card and that can exchange data with the card. Such hosts include, but are not limited to, digital cameras, cellular telephones, personal computers of any type and size, commercial printers, or personal printers with card slots. By “standard host” is meant a host that does not include the provisions of the present invention for identifying the host as an “authorized host”.

A memory card is said to be “locked” if the card is set to prevent the reading of the digital pictures stored therein, even by an authorized host. The locking of a memory card is reversible in the sense that the memory card can be “unlocked” for future reading by erasing the digital pictures. In one embodiment of the present invention, a locked memory card can be unlocked, for the reading of the digital pictures stored thereon, by the camera that took the digital pictures, without having to erase the digital pictures. A memory card is said to be “disabled” if the card is set so that only an authorized host can exchange data with the card.

The present invention provides systems and functionalities for allowing a photographer to use a memory card similarly to using conventional film, by dropping the card at a photo shop for printing.

According to the present invention there is provided a memory device including: (a) a nonvolatile memory; (b) a medium bearing instructions for: (i) storing in the nonvolatile memory, as a corresponding original picture, each of at least one source picture received from a camera, and (ii) for each at least one original picture: producing a corresponding degraded picture; and (c) a processor for executing the instructions.

According to the present invention there is provided a method of digital photography, including the steps of: (a) taking at least one source picture, using a camera; (b) for each at least one source picture, storing a corresponding original picture in a memory device; and (c) for each at least one original picture: producing a corresponding degraded picture, by the memory device.

A memory device of the present invention includes a nonvolatile memory, a processor, and a medium that bears instructions that, when executed by the processor, implement the methods of the present invention. The basic set of instructions includes instructions for storing, in the nonvolatile memory, as a corresponding original picture, each of one or more source pictures received from a camera, and instructions for, for each original picture, producing a corresponding degraded picture.

According to one preferred embodiment of the memory device of the present invention, the instructions for producing the degraded picture(s) include instructions for producing the degraded picture(s) and storing the degraded picture(s) in the nonvolatile memory when the corresponding original picture(s) is/are stored in the nonvolatile memory. According to another preferred embodiment of the memory device of the present invention, the instructions for producing the degraded picture(s) include instructions for producing the degraded picture(s) and storing the degraded picture(s) in the nonvolatile memory while the memory device is idle. According to yet another preferred embodiment of the memory device of the present invention, the instructions for producing the degraded picture(s) include instructions for, in response to a request by a host of the memory device to access one of the original pictures, to produce the corresponding degraded picture and then to send the corresponding degraded picture to the host.

According to one preferred embodiment of the memory device of the present invention, the instructions for storing the original picture(s) in the nonvolatile memory include instructions for storing the original picture(s) in the nonvolatile memory only in encrypted form. According to another preferred embodiment of the memory device of the present invention, the instructions for storing the original picture(s) in the nonvolatile memory include instructions for storing the original picture(s) in the nonvolatile memory in clear (i.e., unencrypted) form. In the latter case, most preferably the medium also bears instructions for, in response to a request by a host of the memory device to access an original picture, encrypting the requested original picture and denying the host access to the clear original picture while allowing the host access to the encrypted version of the requested original picture. Alternatively, the medium also bears instructions for allowing access to the clear original picture(s) only to an authorized host of the memory device.

Preferably, the medium also bears instructions for locking the memory device upon termination of an access of the original picture(s) by an authorized printer. Most preferably, the medium also bears instructions for unlocking a memory device, that has been so locked, by the camera from which the memory device received the original picture(s).

Preferably, the medium also bears instructions for verifying that the memory device is operational, for producing an image of a quality stamp if the memory device turns out to be operational, and for rendering the memory device permanently inoperative if the memory device turns out not to be operational.

Preferably, the medium also bears instructions for disabling the memory device upon reaching a predetermined expiration date.

According to the basic method of the present invention, a camera is used to take one or more source pictures, (a) corresponding original picture(s) is/are stored in a memory device, and the memory device produces (a) corresponding degraded picture(s): for example when the original picture(s) is/are stored (in which case the degraded picture(s) also is/are stored in the memory device) or while the memory device is idle (in which case the degraded picture(s) also is/are stored in the memory device) or when a host requests access to an original picture (in which case the corresponding degraded picture is produced and is sent to the host).

According to one preferred embodiment of the method of the present invention, the original picture(s) is/are stored only in encrypted form. According to another preferred embodiment of the method of the present invention, the original picture(s) is/are stored in clear form. In response to a request by a host of the memory device to access one of the original pictures, the requested original picture is encrypted. The requesting host is allowed access to the encrypted picture but is denied access to the clear original picture. Alternatively, only authorized hosts of the memory device are allowed access to the clear original pictures.

Preferably, the memory device is locked upon termination of an access of the original picture(s) by an authorized printer. Most preferably, a memory device that is so locked is unlocked by the camera that took the source picture(s).

Preferably, the memory device verifies its own operability. If the operability is verified, the memory device indicates that status by producing an image of a quality stamp. Otherwise, the memory device renders itself permanently inoperative.

Preferably, the memory device is disabled upon reaching a predetermined expiration date.

Essentially, the present invention implements one or more of the following features:
a card is received from a printing service provider against a monetary deposit; the deposit is redeemed upon placing an order for prints or receiving another card;
full-quality prints and digital copies of the original pictures can be obtained only at authorized photo shops; otherwise, limited access is possible through thumbnails and/or copies degraded by one or more of size (e.g. resolution), color or marking;
the cards can be reused by others after being erased by the printing machine and/or being disabled by the card's controller;
cards become inoperative for further use (except printing) after a predetermined expiration period.

The features described above offer remedies to the following potentials concerns:
the printing service provider expects the cards to be used for generating printings and be reused as often as possible; any alternative uses are preferably discouraged; the deposit, expiration and limited access to picture files are devised accordingly;
the user may be concerned about his or her privacy, when a card reaches other hands; reliable erasure upon printing protects the user's privacy.

### BRIEF DESCRIPTION OF THE DRAWINGS

The invention is herein described, by way of example only, with reference to the accompanying drawings, wherein:

FIG. 1 is a high-level block diagram of a system of the present invention;

FIG. 2 illustrates the data stored in an embodiment of the memory card of FIG. 1 that stores both original pictures and degraded pictures;

FIG. 3 summarizes the features of the memory card of FIG. 1;

FIG. 4 is a flowchart of photography using the camera and memory card of FIG. 1;

FIGS. 5-9 are flowcharts of various modes of access to the memory card of FIG. 1;

FIG. 10 is a flowchart of a self-test of the memory card of FIG. 1;

FIG. 11A is a flowchart of the setting of an expiration date in the memory card of FIG. 1;

FIG. 11B is a flowchart of photography using the camera and memory card of FIG. 1 with an expiration date set in the memory card of FIG. 1;

FIG. 12A is a flowchart of the provision of editing instructions;

FIG. 12B is a flowchart of the implementation of editing instructions;

FIGS. 13A and 13B illustrate an embodiment of the memory card of FIG. 1 that stores original pictures and creates degraded pictures as needed;

FIG. 14 illustrates an embodiment of the memory card of FIG. 1 that stores original pictures and creates encrypted pictures as needed;

FIG. 15 illustrates an embodiment of the memory card of FIG. 1 that stores encrypted pictures.

### DESCRIPTION OF THE PREFERRED EMBODIMENTS

The present invention is of a memory device and an associated system for digital photography. Specifically, using the present invention, a user of a digital camera can have memory cards printed the way a user of an analog camera has photographic film developed and printed.

The principles and operation of digital photography according to the present invention may be better understood with reference to the drawings and the accompanying description.

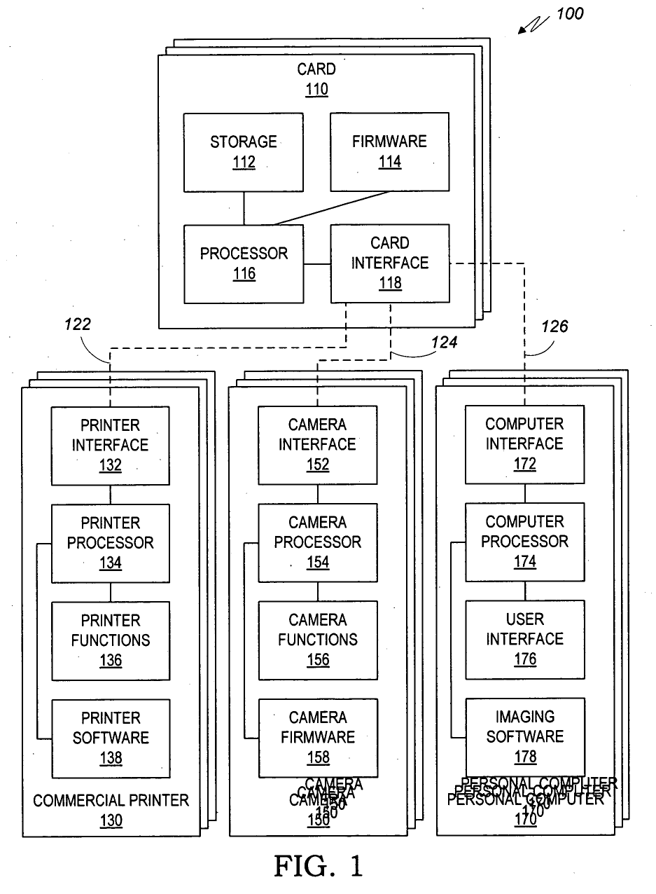

Reference is made to FIG. 1, which is a high-level schematic block diagram of a preferred embodiment 100 of a system constructed in accordance to the present invention. Card 110 is a camera memory card that includes non-volatile storage 112 (e.g. a flash memory or micro magnetic disk drive) that stores images and order data, as described below with reference to FIG. 3; processor 116 operates under firmware 114 that controls the access and management of storage 112; and card interface 118 provides mechanical, electrical and logical interfaces with external devices such as camera 150, commercial printer 130 and personal computer 170. Camera 150 takes photos using camera functions 156, optionally transforms the photos to standard image file format (such as jpeg or tiff) using camera processor 154 that runs under camera firmware 158, and interfaces with card 110 via camera interface 152 to send the source pictures to card 110. Commercial printer 130 receives card 110 and interfaces with card 110 via printer interface 132 for printing photos using printer functions 136 controlled by printer processor 134 running under printer software 138. Personal computer 170 receives card 110 via computer interface 172 and is operated by a user for viewing, selecting and editing digital pictures stored in storage 112.

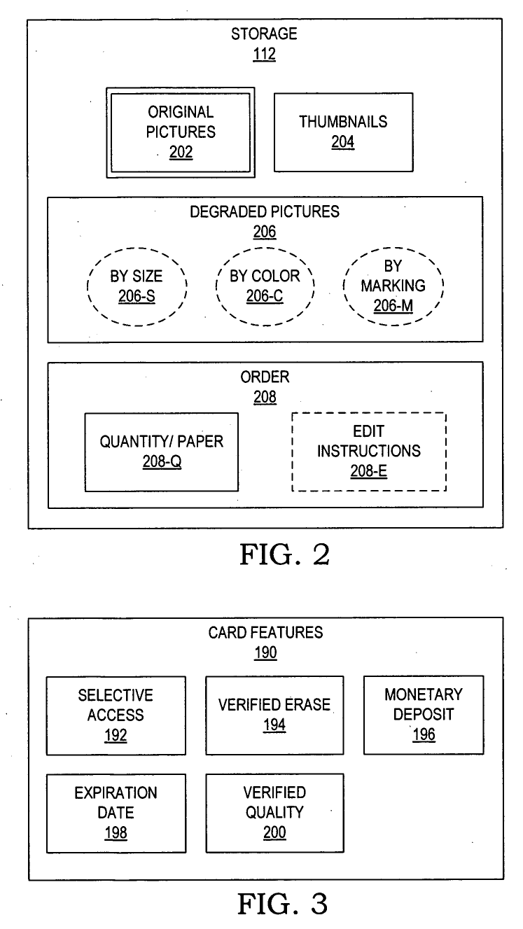

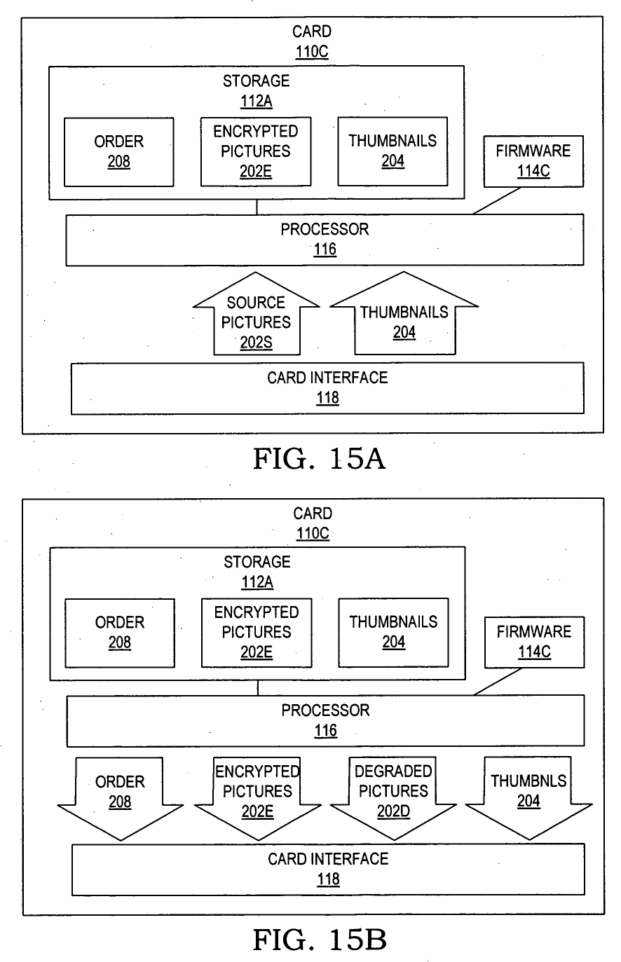

FIG. 2 illustrates the contents of storage 112 of card 110 of FIG. 1. Original pictures 202 are picture files that represent the full quality of the picture as taken by camera functions 156 and processed by camera processor 154. It should be noted that such picture files conventionally include a selectable level of processing by camera processor 154, such as compression or white balance. As described below with respect to FIG. 15A, in some embodiments original pictures 202 are encrypted by processor 116 and are stored in encrypted form. Thumbnails 204 optionally are also conventionally produced by camera processor 154 for providing quick review, on the screen of camera 150, of the pictures stored in storage 112, for viewing and then selecting for erasure or printing. Degraded pictures 206 are degraded versions of original pictures 202, produced by processor 116. Degraded pictures 206 are devised to provide limited viewing, editing and Web-publishing to a user, but to be inadequate for quality printing. Each of degraded pictures 206 is degraded by at least one of the following degradation methods:

degraded by size: 206-S is a reduced-resolution picture, for example to the size of 480×360 pixels (compared to at least 1600×1200 pixels of typical originals);

degraded by color: 206-C reduces the color depth from at least 24b (millions of colors, typical in most originals) to, for example, 8b (256 colors, such as in grayscale representation);

degraded by marking: 206-M is implemented by adding extra visible information to a picture, e.g. by text or graphical watermarks.

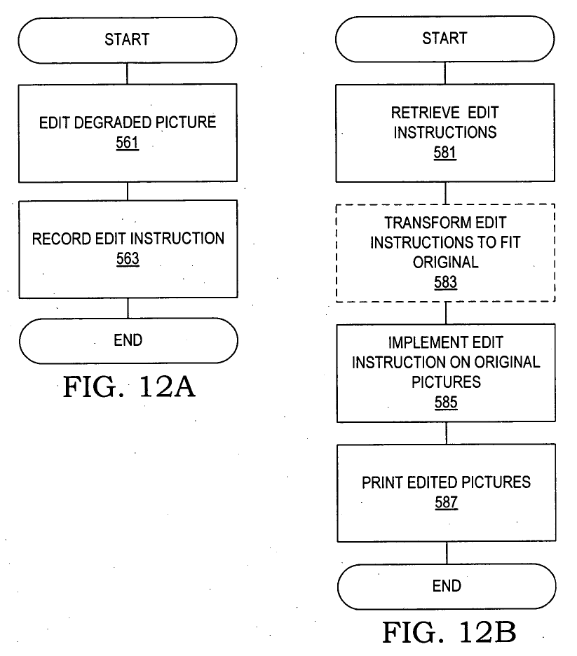

Order 208 stores user commands related to ordering prints from commercial printer 130 of FIG. 1; such commands specify quantity and paper type and size 208-Q, and optionally also edit instructions 208-E, such as cropping, color correction etc. as is customary in digital photograph processing (see FIGS. 12A-B below). Order 208 is responsive to user commands entered in camera 150 or personal computer 170, and is stored either as separate files or as instruction fields within picture files.

It will be noted that thumbnails themselves are degraded representations of the original images. To clearly distinguish between “thumbnails” and “degraded images”, as herein understood, “thumbnails” are optionally produced by the camera's processor, while “degraded images” are produced by the card's processor.

Reference is made to FIG. 3, which symbolically summarizes features, at least one of which is included in various embodiments of the present invention. These features are described in detail below. Selective access 192 provides authorized commercial printers 130 exclusive access to original pictures 202, while other devices such as cameras, personal computers or unauthorized commercial printers obtain access only to thumbnails 204, degraded pictures 206 and order 208. Verified erase 194 is an algorithm implemented within card 110 and/or an authorized trusted commercial printer 130, to ensure that a card is properly erased and “sanitized” before being “recycled”, i.e. handed to another user. Verified erase 194 is important to protect the privacy of the previous user. Monetary deposit 196 records in card 110 the details of a commercial entity that lends the card to users against a monetary deposit, to be redeemed in the future for prints or another card. The record in monetary deposit 196 is used by the redeeming commercial entity for billing and accounting purpose. Expiration date 198 includes a date after which card 110 will be disabled for any further operation except printing at an authorized commercial printer 130, to encourage prompt printing of the pictures stored in card 110. Verified quality 200 is a visible indication for a user, certifying the quality of a “recycled” card 110 after card 110 has successfully passed a built-in test.

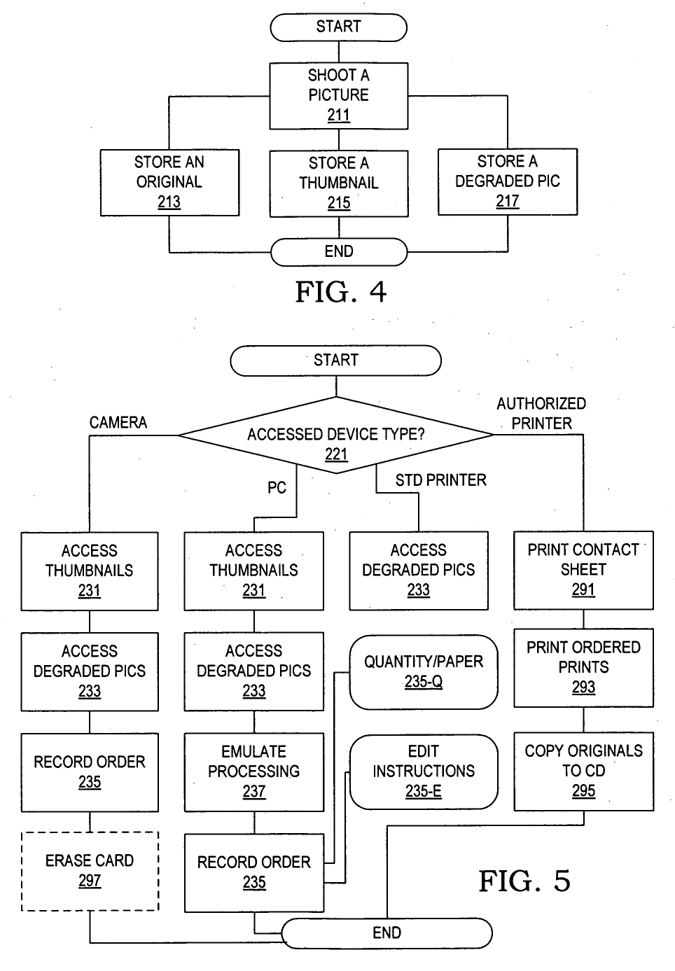

FIG. 4 is a flowchart describing the use of camera 150 having card 110. In a step 211, the user shoots a photo in the conventional manner. The photo is transformed by camera processor 116 into a source picture. In a step 213 the source picture is sent from camera processor 116 to card 110 and is stored as an original picture in the secure storage area for original pictures 202 within storage 112. In a step 215 a thumbnail of the picture is stored as a thumbnail in thumbnails 204, and in a step 217, the picture is processed by card processor 116 to produce a degraded version of the picture to be stored in the area for degraded pictures 206. It will be noted that step 217 is executed autonomously by card processor 116, thus making it transparent to both the shooting habits of the user and the design of camera 150. This implies that card 110 can be used with existing user base and camera models.

While steps 213, 215 and 217 can be executed essentially concurrently for each picture taken in step 211, in an alternative embodiment step 213 is executed immediately after step 211, while step 217 can be deferred to be executed by processor 116 (from an already-stored original picture) at an idle moment when card 110 is energized by camera 150 but is not busy with receiving or sending data. In this way, the processing and storage by step 217 do not slow down picture-taking. It also will be noted that step 215 is not mandatory, and a previously-stored degraded picture can be used for reviewing that picture on the camera's screen.

FIG. 5 describes modes of access to card 110 of FIG. 1 with a camera 150, a personal computer 170, a standard printer 130 or an authorized printer 130. The type of device being used to access card 110 is identified by a step 221. With a camera 150, in addition to taking pictures as described in FIG. 4 and not repeated here, camera 150 can access thumbnails (option 231) for reviewing previously-taken pictures and possibly recording orders (option 235) onto order area 208 of storage 112; under option 233 camera 150 can also access degraded pictures 206 if printing from camera 150 directly to a printer 130 is supported, or if camera 150 is used as a conduit to send pictures to a personal computer 170. Also, camera 150 can erase card 110, including the protected area of card 110 for original pictures 202. It should be noted, however, that camera 150 is not allowed to access the original pictures 202 after shooting them.

Still in FIG. 5, a personal computer 170 can access thumbnails and degraded pictures (options 231 and 233, respectively), that can be viewed and possibly published on the Internet. In option 237 personal computer 170 can also emulate on the degraded pictures a processing intended for the original pictures, depending on the nature of degradation. For example, if the pictures are degraded by size, processing can still relate to cropping and color-balancing. Pictures degraded by color are still useful for emulating cropping, while marked pictures can support all types of processing, including, for example, red-eye removal. In option 235 for recording an order, the order can be specified by definition 235-Q of quantity and paper size and type, and also include the edit instructions 235-E created during the emulated processing 237. These instructions affect printing 293 as explained below.

When step 221 of FIG. 5 determines that the device accessing card 110 is a standard printer 130 (commercial or home printer) connected to card 110 through a reader or through camera 150, only degraded pictures are accessible for printing. If an authorized commercial printer 130 is connected, however, that printer 130 has an option 291 for printing contact sheets, and an option 293 for printing full-quality original pictures from storage 202 according to an order recorded previously under option 235 including quantity and paper type and size 235-Q, and edit instructions 235-E. If such orders have not been recorded, then such quality printing of the original pictures can be made by default of one print per original image or follow the instructions of a written form, as customary with conventional film-based orders. Option 295 also allows an authorized printer 130 to copy original pictures 202 onto a medium such as CD-ROM for further use by the user. The identification by card 110 of a host as an authorized printer is made by cryptographic exchange between card processor 116 and printer processor 134 that proves to card 110 that the host knows a secret (preferably a cryptographic key) known only to authorized printers. Such identification of devices as trusted or authorized devices is well-known in the art and therefore is not elaborated further herein.

It should be noted that the operation and options of FIG. 5 are directed at ensuring that only an authorized commercial printer 130 can access original pictures 202 after original pictures 202 have been received from camera 150. Not even camera 150 can access original pictures 202, except to erase original pictures 202. All other hosts of card 110 have access to thumbnails 204 and degraded pictures 206 only, offering limited functionality of viewing, Web-publishing, editing and ordering. This makes it worth the while, commercially, of the operator of authorized commercial printer 130 that is protected here, to subsidize card 110. This relates to the feature of selective access 192 of FIG. 3.

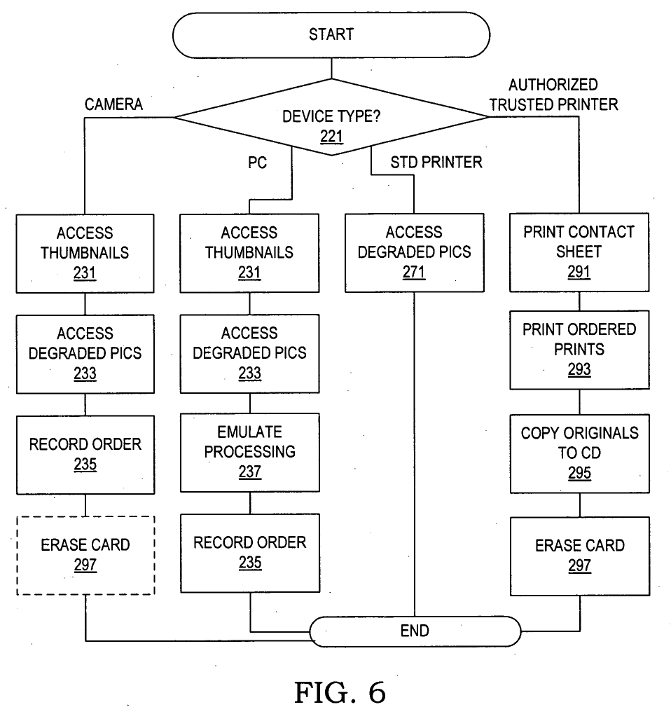

FIG. 6 includes all the options of FIG. 5 (under the corresponding block numbers), and adds one additional option related to the feature of verified erase 194 of FIG. 3. In FIG. 6, authorized commercial printer 130 is not only authorized to access original pictures 202, but is also trusted by users to completely erase and sanitize cards (a step 297) after printing ordered prints (step 293) and/or copying the originals to a CD (step 295). This means that once the user receives quality prints and/or original copies on a CD, s/he can be sure that the card has been properly erased and his/her private pictures will not by accessible when the card is reused by another. Methods for sanitizing cards, i.e. erasing them reliably, are taught in US Patent Application Publication No. 2004/0188710, which document is incorporated by reference for all purposes as if fully set forth herein.

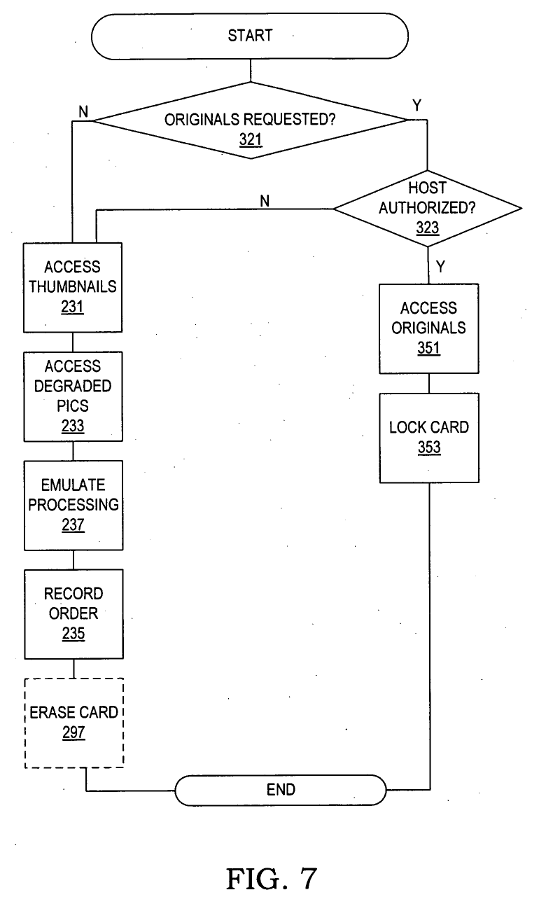

FIG. 7 also relates to the feature of verified erase 194 of FIG. 3. However, it is presumed in the embodiment of FIG. 7 that the user does not trust commercial printer 130 but does trust card 110 to erase itself after original pictures 202 have been accessed for printing or copying. In this case, any host (camera 150, personal computer 170, printer 130, etc.) can access thumbnails (option 231), degraded pictures (option 233), emulate processing on degraded pictures (option 237), or erase cards (option 297). However, when a host attempts accessing original pictures 202 (step 321), it is determined in step 321 whether that host is an authorized printer. An authorized printer is allowed a single session of access to originals 351 (for printing and copying), but when the session is over, card 110 is locked in a step 353 and must be thoroughly erased in order to become functional again. The programming of this locking, embedded in firmware 114 of card 110, ensures that the very fact that the user has received hi-quality prints and/or original copies on a CD, proves that the included pictures have been protected by the card processor against further access when the card is recycled (i.e. reused by another). Any host that attempts to access card 110 after card 110 has been locked is denied access to original pictures 202 as well as to thumbnails 204 and to degraded pictures 206, thus protecting the privacy of the original user.

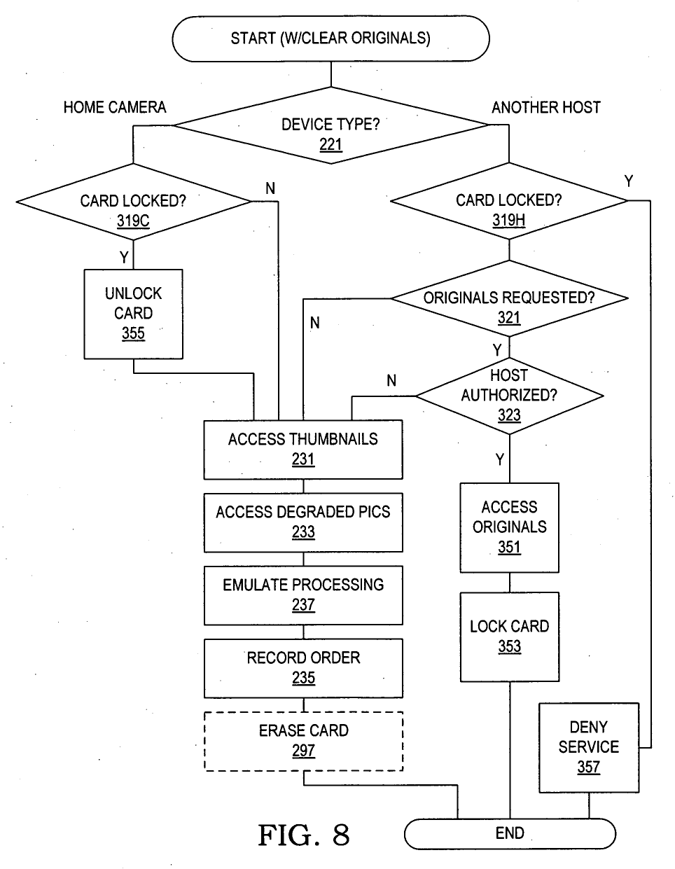

FIG. 8 describes still another variation of FIGS. 6 and 7. In FIG. 8 a camera 150 that has formatted a card 110 (hereinafter “home camera” 150) is identified to that card 110 in step 221. Although such identification is not standard in the current art of digital camera cards, the ability of devices that interface with each other to identify the other device by a serial number or another unique ID is well supported by the art. In such a case, if card 110 is not locked (step 319C) the home camera 150 can access thumbnails 204, degraded pictures 205 and original pictures 202 (e.g. for printing) as represented by blocks 231, 233, 235 and 297. If card 110 has been locked because card 110 has been accessed by an authorized printer, the camera 150 that took the source pictures has the ability 355 to unlock card 110 and then to access thumbnails 204, degraded pictures 205 and original pictures 202. This provides two advantages that enhance the configuration of FIG. 7. First, if the user retrieves from commercial printer 130 his/her original card, s/he can add pictures to the same card instead of erasing the card. Second, if there was a fault in a host that has accessed the original pictures 202 but did not copy them all, original pictures 202 can be rescued by the home camera 150. Any other host accesses card 110 as illustrated in FIG. 7, unless card 110 has been locked (step 319H), in which case access to card 110 is denied.

As described above, the authentication of authorized printers 130 by card 110 is made by cryptographic techniques known in the art, and preferably but not necessarily by using asymmetric keys.

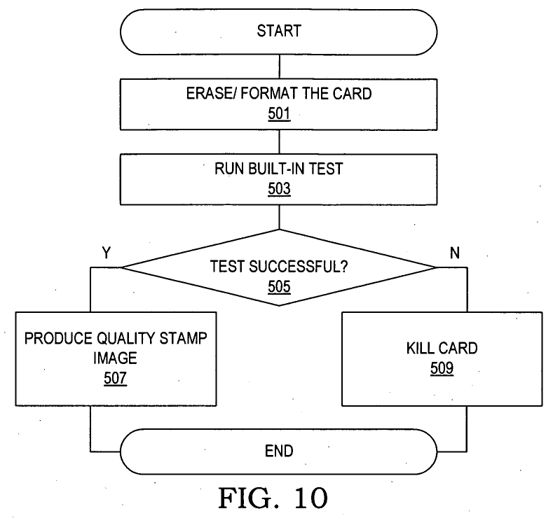

FIG. 10 schematically describes the verified quality 200 feature of FIG. 3. A user who receives a recycled card 110 wishes to be assured that the card 110 is perfectly operational. For this purpose, after the card 110 has been formatted is a step 501 by a printer 130, a personal computer 170 or a camera 150, in a step 503 processor 116 runs automatically a built-in test. If the test is found successful in a step 505, then processor 116 produces a synthetic image of a quality stamp that shows as a normal picture when viewed through a camera screen or a personal computer. Otherwise the card 110 is made permanently inoperative in a step 509, and any host of card 110, such as a camera 150, a personal computer 170 or a printer 130, will detect a malfunctioning card 110 under a standard procedure as known in the art.

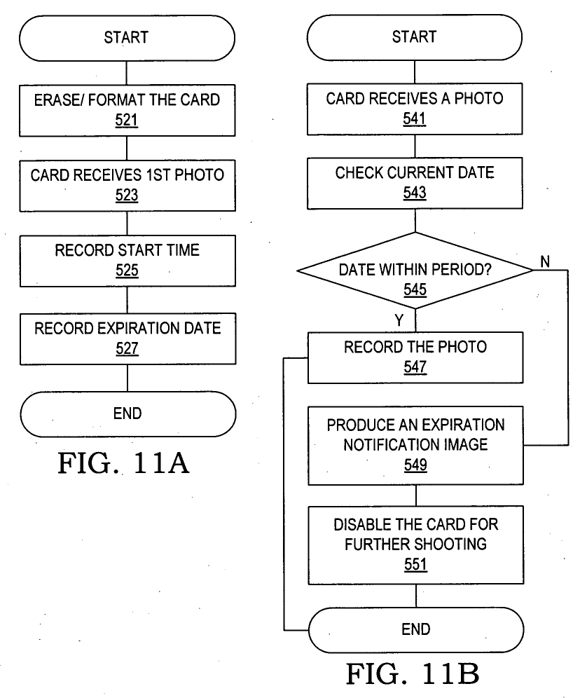

FIGS. 11A and 11B describe the feature of expiration date 198 of FIG. 3, as executed by card processor 116. In a step 521 a card is formatted. In a step 523 the card 110 receives the first photo from camera 150; under standard file formats, the photo includes the current date. In a step 525 the current date is recorded in storage 112 of card 110 as the start date. In a step 527 the expiration date is calculated, e.g. by adding 90 days to the start date.

In a step 541, a picture file other than the first picture after formatting, is received by card 110. In a step 543, processor 116 checks the current date from the received file, and in a step 545 processor 116 checks whether the current date is within the allowed period, i.e., after the start date and before the expiration date previously recorded in storage 112 through steps 525 and 527. If the date is within the allowed period, then in a step 547 the picture is recorded normally into storage 112; otherwise, in a step 549, processor 116 synthesizes an image notifying that the card 110 has expired and encouraging the user to print his/her images 202 at an authorized printer 130. In a step 551, card 110 is placed into a read-only mode, i.e., is disabled for further shooting while the reading functionalities remain intact. This mode does not preven formatting, and is reset when card 110 is reformatted.

FIGS. 12A and 12B schematically describe the emulated processing step 237 of FIGS. 5-9, and the respective outcome which is implicitly included in printing the ordered prints step 293 in the same Figures. Thus, in a step 561 the user uses personal computer 170 to load a degraded picture from the area of degraded pictures 206 of storage 112 (FIG. 2) and edit the degraded picture. Editing options are dependent on the degradation method used to produce a degraded picture: degradation by color allows primarily cropping; degradation by size allows cropping and limited color and contrast manipulation; degradation by marking allows all customary editing options, including cropping, color and contrast manipulation, digital filters, red-eye removal and special effects. In a step 563, the edit instructions related to the current degraded picture (edit instructions 208-E of FIG. 2) are recorded by the editing software running on personal computer 170 onto storage 112 of card 110. The technique of recoding editing parameters is well known, for example from the art of editing digital images taken in RAW format.

FIG. 12B describes how the edit instructions recorded in step 563 are implemented to effect step 293 or 351 of printing in FIGS. 5-9. In a step 581 an authorized commercial printer 130 (FIG. 1) accesses storage 112 to retrieve original pictures 202 and the parameters of order 208. For each specific original picture whose printing quantity (included in quantity/paper instructions 208-Q) is not null, edit instructions 208-E are sought. If instructions 208-E have previously been recorded in step 563 (FIG. 12A) then instructions 208-E are retrieved in step 581. In a step 583, if the degraded image used in step 561 was of a different size (e.g. of degraded resolution), the edit instructions that relate to specific locations on the picture are transformed to fit the full size of the original. In a step 585 the edit instructions 208-E are implemented on the respective original pictures and in a step 587 the edited versions are then printed according to the specified quantity and paper type and size in instructions 208-Q.

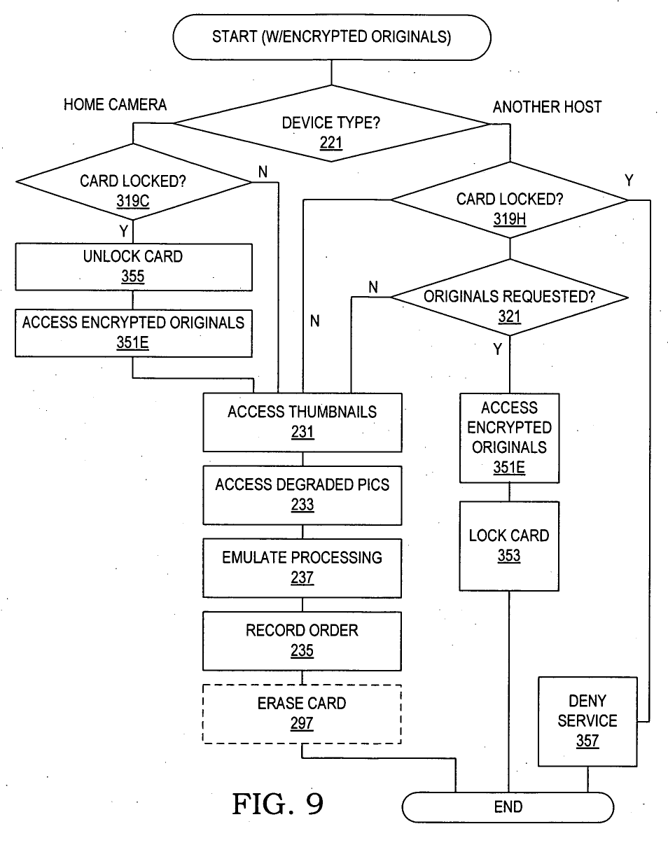

FIGS. 9 and 13A through 15B relate to additional preferred embodiments and to variations of the way that processor 116 of FIG. 1 processes and protects the original image data.

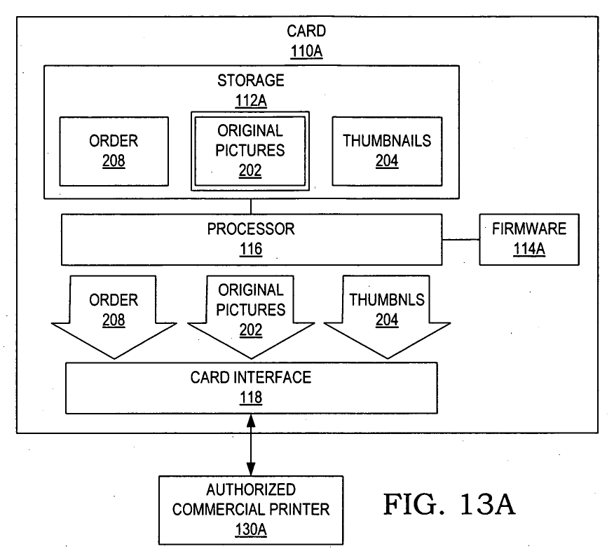

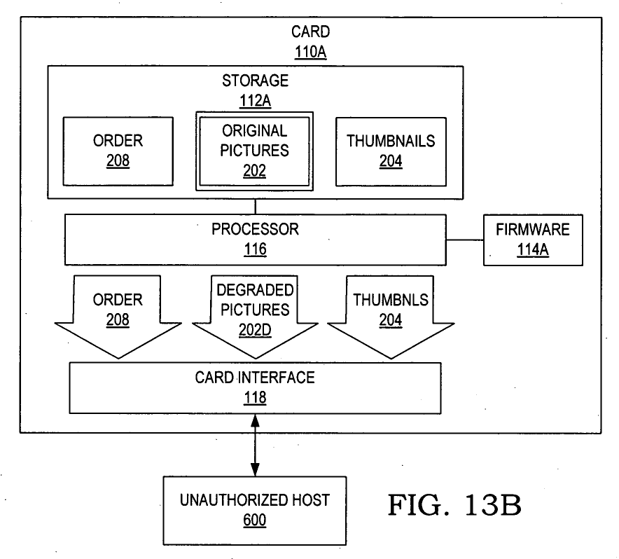

Reference is now made to FIGS. 13A and 13B that illustrate an alternative embodiment to the embodiment of FIG. 2. Whereas in the embodiment of FIG. 2 degraded pictures 206 were produced by processor 116 and stored within storage 112, the alternative embodiment of FIGS. 13A and 13B keeps only the original pictures 202 in storage 112A (optionally along with thumbnails 204 and order 208) and processor 116 is operative to identify an authorized commercial printer 130A and provide the original pictures 202 through card interface 118. When interfacing with a unauthorized host 600 (FIG. 13B), processor 116 executing firmware 114A produces on-the-fly degraded pictures 202D from original pictures 202 and provides degraded pictures 202D to any unauthorized host 600 (optionally along with thumbnails 204 and order 208) through card interface 118. The embodiment of FIGS. 13A and 13B saves the memory needed for degraded pictures 206 (FIG. 2) and the processing time of step 217 (FIG. 4), but increases the time needed to read pictures by an unauthorized host 600 (FIG. 13B) by the processing time required by processor 116 to produce the uploaded degraded pictures 202D.

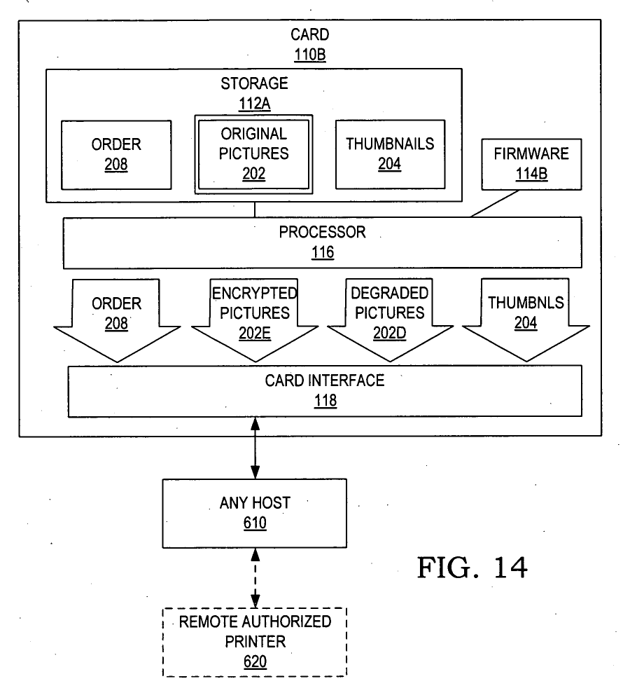

FIG. 14 illustrates another preferred embodiment, in which the protected original pictures 202 are both encrypted and degraded on-the-fly by processor 116 under firmware 114B, for selectably providing both an encrypted version 202E and/or a degraded version 202D to any host 610. The encrypted version 202E is useful only at authorized commercial printers that have the required keys in order to decrypt the original pictures, print the original pictures and/or burn the original pictures onto a CD as described above, while the degraded version is useful for all hosts for the purposes described above. Furthermore, any personal computer or similar host 610 that can connect to a remote authorized printer 620 through the Internet, cellular communication or any other electronic communication link, can transfer encrypted pictures 202E to a remote authorized printer 620 for printing.

FIG. 9 shows how FIG. 8 is modified under the preferred embodiment in which original pictures 202 are stored in card 110 in encrypted form. After unlocking card 110 in step 355, home camera 150 has access to encrypted original pictures 202 in step 351E, and also the other permissions of steps 231, 233, 237, 235 and 297. Any other host also has access to encrypted original pictures 202, but encrypted original pictures 202 are useless to any host other than an authorized printer. After access of encrypted original pictures 202 by an authorized printer, card 110 preferably is locked in step 353 to protect the privacy of the user, as explained with respect to FIG. 8.

FIGS. 15A and 15B illustrate another preferred embodiment of the present invention in which the original pictures are kept encrypted. FIG. 15A shows card 110C attached to a camera and operating in a picture-taking mode. Source pictures 202S are received from the camera through card interface 118 and are encrypted on-the-fly by processor 116 under firmware 114C for storing the original pictures as encrypted original pictures 202E in storage 112A. Thumbnails 204 optionally are supplied by the camera and stored in storage 112A, and order 208 is recorded by any host at any time, as described with respect to FIGS. 13A, 13B and 14 above. Thus, no original image is stored or needs to be hardware-protected on storage 112A. When connected to any host for output (FIG. 15B), processor 116 executing firmware 114C selectably provides any of order 208, thumbnails 204, encrypted pictures 202E, or degraded pictures 202D produced on-the-fly by processor 116 from encrypted pictures 202E, possibly via decrypting followed by degrading. The usage of the encrypted version 202E is as described with respect to FIG. 14 above.

It should be noted that, under most practical scenarios, accessing degraded pictures by an authorized printer is redundant and may never be used. In the embodiments in which the originals are stored in clear in card 110 and are protected by processor 116 against access by any host other than an authorized printer, the originals preferably remain hidden from the user, who sees only the degraded versions instead. In embodiments in which card 110 produces both encrypted originals and degraded versions, users preferably ma access both versions, because although encrypted originals are useless for any host other than an authorized printer, the user may want to send an encrypted original to an authorized printer by other means, e.g. as an e-mail attachment.

While the invention has been described with respect to a limited number of embodiments, it will be appreciated that many variations, modifications and other applications of the invention may be made.

What is claimed is:

1. A memory device comprising:
(a) a nonvolatile memory;
(b) a medium bearing instructions for:
(i) storing in said nonvolatile memory, as a corresponding original picture, each of at least one source picture received from a camera, and
(ii) for each said at least one original picture: producing a corresponding degraded picture; and
(c) a processor for executing said instructions.

2. The memory device of claim 1, wherein said instructions for producing said at least one degraded picture include instructions for producing each said degraded picture and then storing said each degraded picture in said nonvolatile memory when said original picture, to which said each degraded picture corresponds, is stored in said nonvolatile memory.

3. The memory device of claim 1, wherein said instructions for producing said at least one degraded picture include instructions for producing said at least one degraded picture and then storing said each degraded picture in said nonvolatile memory while the memory device is idle.

4. The memory device of claim 1, wherein said instructions for producing said at least one degraded picture include instructions for, in response to a request by a host of the memory device to access one of said at least one original picture, producing said degraded picture that corresponds to said one original picture and then sending said degraded picture to said host.

5. The memory device of claim 1, wherein said instructions for storing said at least one original picture in said nonvolatile memory include instructions for storing said at least one original picture in said nonvolatile memory only in encrypted form.

6. The memory device of claim 1, wherein said instructions for storing said at least one original picture in said nonvolatile memory include instructions for storing said at least one original picture in said nonvolatile memory in clear form.

7. The memory device of claim 6, wherein said medium also bears instructions for:
(iii) in response to a request by a host of the memory device to access one of said at least one original picture:
(A) encrypting said one original picture;
(B) denying said host access to said one original picture while allowing said host access to said encrypted original picture.

8. The memory device of claim 6, wherein said medium also bears instructions for:
(iii) allowing access to said at least one original picture only to an authorized host of the memory device.

9. The memory device of claim 1, wherein said medium also bears instructions for:
(iii) upon termination of an access of said at least one original picture by an authorized printer: locking the memory device.

10. The memory device of claim 9, wherein said medium also bears instructions for:
(iv) unlocking the memory device by said camera.

11. The memory device of claim 1, wherein said medium also bears instructions for:
(iii) verifying that the memory device is operational;
(iv) if the memory device is operational: producing an image of a quality stamp; and
(v) otherwise, rendering the memory device permanently inoperative.

12. The memory device of claim 1, wherein said medium also bears instructions for:
(iii) upon reaching a predetermined expiration date: disabling the memory device.

13. A method of digital photography, comprising the steps of:
(a) taking at least one source picture, using a camera;
(b) for each said at least one source picture, storing a corresponding original picture in a memory device; and
(c) for each said at least one original picture: producing a corresponding degraded picture, by said memory device.

14. The method of claim 13, wherein said at least one degraded picture is produced, and is stored in said memory device, when said at least one corresponding picture is stored in said memory device.

15. The method of claim 13, wherein said memory device produces and stores at least one degraded picture while said memory device is idle.

16. The method of claim 13, wherein, for any said original picture, said corresponding degraded picture is produced, and is sent to a host of the memory device, in response to a request by said host to access said any original picture.

17. The method of claim 13, wherein said at least one original picture is stored in said memory device only in encrypted form.

18. The method of claim 13, wherein said at least one original picture is stored in said memory device in clear form.

19. The method of claim 18, further comprising the step of, in response to a request by a host of said memory device to access one of said at least one original picture:
(d) encrypting said one original picture, by said memory device; and
(e) denying said host access to said one original picture while allowing said host access to said encrypted original picture.

20. The method of claim 18, further comprising the step of:
(d) allowing access to said at least one original picture only to an authorized host of said memory device.

21. The method of claim 13, further comprising the step of:
(d) upon termination of an access of said at least one original picture by an authorized printer: locking said memory device.

22. The method of claim 21, further comprising the step of:
(e) unlocking said memory device, by said camera.

23. The method of claim 13, further comprising the steps of:
(d) verifying that said memory device is operational, by said memory device;
(e) if said memory device is operational: producing an image of a quality stamp, by said memory device; and
(f) otherwise, rendering the memory device permanently inoperative.

24. The method of claim 13, further comprising the step of:
(d) upon reaching a predetermined expiration date: disabling said memory device.
